(19) United States
(12) Patent Application Publication
(10) Pub. No.: US 2008/0144762 A1
(43) Pub. Date: Jun. 19, 2008

(54) Non Proliferating Thorium Nuclear Fuel Inert Metal Matrix Alloys for Fast Spectrum and Thermal Spectrum Thorium Converter Reactors

(76) Inventors: Charles S. Holden, San Francisco, CA (US); Tak Pul Lou, Berkeley, CA (US)

Correspondence Address: STAINBROOK & STAINBROOK, LLP, 412 AVIATION BOULEVARD, SUITE H, SANTA ROSA, CA, 95403, US

(21) Appl. No.: 11/815,732

(22) PCT Filed: Mar. 2, 2006
(86) PCT No.: PCT/US2006/007589

§ 371 Date: Aug. 7, 2007

Related U.S. Application Data
(60) Provisional application No. 60/658,924, filed on Mar. 4, 2005.
(60) Provisional application No. 60/667,185, filed on Mar. 30, 2005.

(51) Int. Cl. G21C 3/07

(52) U.S. Cl. 376/416

(57) ABSTRACT

A set of alloy formulations is disclosed to use with thorium based nuclear fuels in a fast spectrum reactor; with thorium based nuclear fuels in existing thermal spectrum power reactors; for medical isotope production in the epithermal, the fast, the fission spectrum and the thermal spectra; and to use as fuel in test and experimental reactors that are non proliferative. The alloys form inert metal matrixes to hold fine particles of dispersed thorium containing fuel. The formulations also are useful for the production of medical and commercial isotopes in the high energy, fast and epithermal neutron spectra.

### STATEMENT REGARDING FEDERALLY SPONSORED RESEARCH OR DEVELOPMENT

The United States Government has rights in the invention disclosed in the United States provisional patent applications, claimed as priority documents in the PCT Request, pursuant to Work for Others Agreement No. LB05-001446 between Charles S. Holden, the Regents of the University of California as the Management and Operating Contractor for the Ernest Orlando Lawrence Berkeley National Laboratory Operating and Prime Contract No. DE-AC03-76SF00098 for the U.S. Department of Energy.

### BACKGROUND OF THE INVENTION

1. Technical Field

The present invention relates generally to novel alloy formulations employed in a variety of fields, including formulations for use in thorium-based nuclear fuels in fast spectrum reactors, formulations for use in thorium-based nuclear fuels in existing thermal spectrum power reactors, and formulations for use in medical isotope production in the epi-thermal, fast, fission spectrum, and thermal spectra; and, finally, formulations for use as fuel in non-proliferative test and experimental reactors.

2. Background Discussion and Discussion of Related Art

As more uranium 232 and less uranium 238 is added to denature the fissile uranium a significant heat and radiation barrier is introduced into the fuel to supplement the isotopic separation barrier. These aspects promote non-proliferation as does the lack of significant quantities of plutonium and other minor actinides in the spent fuel. The alloys form inert metal matrixes to hold fine particles of dispersed thorium in metallic or ceramic form and a fissile material in ceramic or metallic form for a non-proliferating self regulating fuel.

Generally, thorium cycle nuclear fuels are preferable to uranium-plutonium cycle nuclear fuels because thorium-uranium fuels produce much less plutonium and minor actinides in the reactor than uranium-plutonium fuels do. In particular, this invention relates to nuclear fuel assembly alloys to hold dispersed fertile and fissile fuel particles. The alloy is composed of novel formulations of aluminum-nickel-zirconium-vanadium metals for high energy, fast spectrum and epithermal applications and another class of nuclear fuel assembly alloys composed of novel formulations of aluminum-vanadium-zirconium alloys for thermal spectrum applications. For all spectra, ceramic or metallic nuclear fuel particles containing thorium and at least one fissile actinide are dispersed homogeneously throughout the selected metals comprising the alloy to constitute the novel fuel assembly. The fuel in a matrix application can be adapted to test reactors or experimental reactors to reduce the percentage of heavily enriched uranium 235 used in the fuel.

The same alloys can also be used to fashion target assemblies for the production of medical isotopes, in the high energy, fast, epithermal, and thermal neutron spectrum by means of shaping or tailoring techniques accomplished by the computationally engineered addition of hydrides, borides or nitrides to the components of the target assembly placed between the fuel or driver rods and the target material. In the case of medical isotope production, the fissile and fertile materials in particle, granular or very thin foil form are dispersed in the alloy in different and higher concentrations than those used for fuel purposes, and the foils, tubes, or plates containing the selected target isotope(s) are kept in close contact with the fissile material to efficiently produce the desired isotope product(s) with the invented alloy matrix managing heat, retaining the fission products and shaping the energy of the neutron spectrum encountered by the target to optimize production of the isotope or isotopes of commercial or medical or scientific interest in the target.

The first novel fuel assembly alloy disclosed, containing aluminum-nickel-zirconium-vanadium and hydrogen, permits design and construction of compact, small, transportable nuclear reactors able to more efficiently convert thorium 232 to uranium 233 in the fast neutron spectrum. This first alloy can be used to hold dispersed ceramic or metallic nuclear fuel particles in a fuel matrix that permits design of small nuclear reactors able to efficiently fission away potentially explosive reactor grade plutonium, and/or minor actinides, neptunium, americium and curium from light water reactor spent fuel as a superior means to remediate the transuranic materials from spent light water reactor fuel and to eliminate these troublesome long lived radio-toxic materials from the environment permanently.

The first fuel assembly alloy disclosed, containing nickel, aluminum and zirconium and some hydrogen and dispersed thorium particles in metallic or ceramic form and particles of a selected fissile material or materials, such as uranium 233, uranium 235, plutonium 239, plutonium 241 and or americium 243 in metallic or ceramic form will enable the development of a fast spectrum, small reactor. The reactor would be small enough to be transportable, its fuel will be self regulating and it will produce process heat for many applications: electrical power generation, district heat, sea water desalinization and/or process heat for petrochemical synthesis of carbon containing materials to make transportation fuels.

The second fuel assembly alloy disclosed, containing vanadium, aluminum, zirconium and hydrogen with dispersed ceramic or metallic thorium particles and selected particles of one or more fissile materials mentioned above enables the development of fuel assemblies for existing thermal spectrum power reactors and certain test or experimental reactors. This alloy can be combined with hydrogen so that hydrogen within an intermetalic compound of vanadium aluminum zirconium alloy functions as a thermalizing moderator for neutrons. This innovation provides existing power reactor operators the option of fueling existing uranium-plutonium cycle reactors with non-proliferative thorium cycle fuels.

The above disclosed alloys can also be used to facilitate the production of commercial and medical isotopes. The isotope in elemental form or as a chemical compound comprising the neutron target material would be enveloped by the alloy containing the selected fissile and the selected fertile particle materials including thorium so as to provide various target materials with the opportunity to be irradiated by neutrons in the fast, epi-thermal and thermal spectrums selected for the most efficient production of the commercial or medical isotope desired. There will be a higher flux of energetic neutrons in the immediate vicinity of the fissile particles or grains enclosed by the alloy, the selected fissile material and the targets being either in foils in contact with one another or in the inert alloy as dispersed particles.

Generally, the invented novel nickel-aluminum-zirconium-vanadium alloys are considered to be used as an inert metal matrix, a medium, to hold dispersed ceramic or metallic actinide particles as a nuclear fuel assembly or as an isotope target assembly for the production of commercial or medical isotopes. These alloys constituting the fuel assembly matrixes advance the art for the thorium-uranium fuel cycle for applications in the fast neutron spectrum or the epithermal spectrum using nickel aluminum zirconium vanadium and, in the thermal neutron spectrum with aluminum zirconium vanadium and hydrogen or deuterium (but without nickel in the thermal application), the alloy assists the efficacy of neutronic conversion of thorium 232 to fissile uranium 233 as fewer neutrons are lost in the fast spectrum and by use of the hydrides in the matrix fewer are lost in the thermal spectrum to light water moderation. The various novel nickel-aluminum alloy formulations hold by envelopment dispersed ceramic or metallic actinide particles enabling a fast neutron spectrum to exist for a controlled nuclear chain reaction with the primary fertile actinide being thorium. The fast spectrum promotes uranium 233 conversion/production efficiencies from thorium 232 allowing efficient, compact power reactors to exploit the cleaner thorium fuel cycle. The nuclear fuel is comprised of selected fertile/fissile fuel mixes containing fertile thorium and fissile uranium 233, uranium 235 and/or reactor grade plutonium in ceramic or metallic form dispersed in the alloy selected for the application desired in computationally engineered concentrations.

Novel aluminum-nickel-zirconium-vanadium alloys are used as an inert medium to hold dispersed ceramic actinide particles as a nuclear fuel assembly to advance the cleaner thorium fuel cycle. The various novel nickel aluminum alloy formulations hold dispersed ceramic or metallic actinide particles enabling a fast neutron spectrum that promotes uranium 233 production efficiencies allowing efficient, compact power reactors to exploit the thorium fuel cycle and making possible cores that will provide useful heat for a decade or more.

The nuclear fuel is comprised of selected fertile/fissile fuel mixes with hydrides and nitrides, oxides or borides added in the fast spectrum or epithermal spectrum applications for spectrum tailoring or shaping purposes and added for thermal spectrum applications for spectrum tailoring or shaping effects sufficient to provide the level of moderation suitable for the application. The second alloy disclosed, vanadium-aluminum-zirconium, is for thermal spectrum applications. It holds dispersed ceramic or metallic fuel particles with the primary fertile actinide being thorium and the fissile actinide being also dispersed as metallic or ceramic fuel particles, the fissile metals and the fertile metal being initially alloyed or blended. This second alloy absorbs and retains considerable hydrogen or deuterium well at high temperatures in excess of 1100 degrees C. As a high temperature hydride, this alloy can be used with hydrided or deuterated particles of metallic thorium or simply as a high temperature hydride to moderate the neutrons to thermal ranges efficiently. In this way this alloy functions in place of a water moderator in whole or part in a thermal spectrum reactor. This allows the light water in the thermal reactor to serve more for heat transfer working fluid purposes than as a moderator needed to thermalize the neutrons from the fission. Thus, less water volume is needed in the core and the thorium containing fuel assemblies can be designed to more completely fill the volume of the existing space originally designed for the uranium-plutonium fuel. This provides for tighter pitched lattices allowing deeper burning of the fuel and a longer fuel life because much fewer neutrons are lost to the light water moderator.

The innovation takes advantage of aluminum's relative transparency to neutrons and the addition of the other metals in various amounts makes possible higher temperature applications in the reactor whether the spectrum is thermal, epithermal or fast. Zirconium provides good hydrogen trapping or sealing ability. Nickel and/or vanadium are present to promote neutron scattering, nickel with aluminum for the fast spectrum and vanadium with aluminum for the thermal spectrum, and a blend both nickel and vanadium with aluminum for the epithermal spectrum.

The fuel particles or grains disclosed here are either sand sized grains to very fine dust sized granular particles comprised of a mix of actinides, a mix of intermetalic hydrides under various coatings of carbide, oxide, nitride, boride or silicide with the grains dispersed in an inert metal matrix of aluminum, vanadium, zirconium and/or nickel doped with lanthanides in oxide form as needed to control excess reactivity.

The novel inert metal matrix that contains nickel functions as a trapping medium for fast, intermediate range and epi thermal neutrons, and the various coatings function as fission product barriers and hydrogen barriers when enveloped by the innovative alloys.

These aluminum-containing alloys can be used to produce medical isotopes in the fast spectrum and fission spectrum as well. The neutron spectrum can be made harder by increasing the proportion of fissile material in the matrix alloy to provide neutron multiplying effects so that certain isotopes can be more efficiently produced in the high energy, fast or epithermal spectrum in the innovative target assembly system. The assembly can be irradiated by thermal neutrons which fission the selected fissile actinide in contact with the target material. The fission neutrons impacting or interacting with the target isotopes will have a faster, harder spectrum than thermal neutrons, so the target material will be irradiated with fast neutrons to effectively produce selected commercial and medical isotopes.

Thorium in the matrix alloy acts as the fertile material, controlling excess fission by absorbing or capturing neutrons more energetic that those in the thermal spectrum that are most likely to cause fission in any of the fissile materials selected.

The other formulations of the alloy that do not contain nickel may use hydrogen as the moderating medium for applications in relevant thermal spectrum environments. These applications include non-proliferative and cleaner burning fuels for existing and production modules for making commercial and medical isotopes. The amount of hydrogen to any formulation of the alloys will tailor the spectrum to achieve the closest fit between the resonance capture cross-section of the desired target isotope material and the spectrum of neutrons to which the target isotope material is exposed.

The use of hydrides in nuclear fuels has been disclosed in the literature. Zirconium hydride is disclosed and discussed in U.S. Pat. No. 3,127,325, to Taylor, et al. U.S. Pat. No. 4,493,809, to Simnad, discloses the benefits of thorium hydride, and suggests that thorium hydride functions better than zirconium hydride as a moderator because it has a higher dissociation temperature. U.S. Pat. No. 4,186,050, to West, describes a boiling water reactor design disclosed that uses fissile uranium well below the non-proliferative limit in a matrix of zirconium hydride that is doped with the lanthanide erbium. The erbium was stated to control excess reactivity in the fuel fissile uranium fuel.

U.S. Pat. No. 6,026,136, to Radkowsky, teaches the benefits ofthorium fuels in thermal reactors. This extends Radkowsky's prior seed and blanket concepts to the retrofitting of a specified Russian thermal reactor core to provide it with a seed and blanket fuel array called a “seed and blanket unit” to consume plutonium without generating significant additional weapons proliferative plutonium containing waste products. One embodiment of Radkowsky's invention is disclosed as his non-proliferative light water reactor. The Radkowsky concept disclosed in this patent is to place metallic uranium 235 with metallic uranium 238 in a fuel pin so that the fissile uranium 235 does not exceed 20% of the mass of the uranium in a metallic alloy of zirconium and uranium or uranium oxide in a zirconium alloy matrix in the center of a tube as the seed and to surround the seed with a blanket of thorium 232 with a smaller percentage of uranium 235 and 238. The blanket materials surrounding the seed tube are oxides of thorium and uranium. The seed tube produces neutrons for the blanket to absorb to produce uranium 233. The moderator and heat transport fluid is light water for all of the Radkowsky embodiments and thus, the spectrum is thermal for all of the Radkowsky embodiments. This reactor converts thorium 232 to uranium 233 as it produces power and heat. The disclosures from the Radkowsky patent concern a specific fuel plan for a thermal reactor for one particular type of Russian thermal reactor that is said to be useful to dispose of weapons and reactor grade plutonium and to produce electric power.

The prior art does not disclose or advance the use of fuel assembly nickel aluminum zirconium vanadium alloys containing hydrides in nuclear fuels for use in the thermal spectrum. Further, the prior art does not disclose hydrided fuel elements and configurations in variously formulated inert metal matrix alloys such as are disclosed herein. These alloys share a common attribute: Each is employed to convert thorium to uranium 233 efficiently in a thermal, an epithermal, intermediate, or fast neutron spectrum, or to convert one isotope to commercially useful ones for industrial and medical applications.

The foregoing patents and prior art devices reflect the current state of the art of which the inventor is presently aware. Reference to, and discussion of, these patents is intended to aid in discharging Applicant's acknowledged duty of candor in disclosing information that may be relevant to the examination of prospective claims to the present invention. However, it is respectfully submitted that none of the above-indicated patents disclose, teach, suggest, show, or otherwise render obvious, either singly or when considered in combination, the inventions described herein concerning aluminum alloys advancing the use of thorium as a nuclear fuel in thermal, epithermal and fast neutron spectra or for the production of useful commercial and medical isotopes.

### DISCLOSURE OF INVENTION

The present invention is a set of non-proliferating thorium nuclear fuel inert metal matrix alloys for thorium converter reactors and other applications, which employs thorium in a novel set of inert metal alloys as a non-proliferating nuclear fuel assembly. The fuel assembly is comprised of various formulations of the nickel aluminum zirconium alloy (sometimes referred to herein as “NAZ”) for fast and epithermal spectrum applications or vanadium aluminum zirconium alloy (sometimes referred to herein as “VAZ”) for thermal spectrum applications. The NAZ or the VAZ formulated inert metal matrix are designed to hold homogeneously dispersed ceramic actinide particles (sometimes referred to herein as “CAP”) or metal actinide particles (sometimes referred to herein as “MAP”) dispersed within. This allows for better heat movement or heat transfer from the actinide to the coolant and a more robust fuel assembly for long term use in the core. The ceramic actinide particles for dispersal and inclusion in the matrix include thorium oxide with uranium 233 oxide or uranium 235 oxide or reactor grade plutonium oxide. Likewise, thorium carbide with uranium carbide or the corresponding borides, thorium boride and uranium boride, or the corresponding silicides or corresponding nitride counterparts, thorium nitride and uranium nitride are representative CAP materials for either VAZ or NAZ.

Importantly, reactor grade plutonium oxide is a CAP material as are the oxides of minor actinides oxides along with corresponding nitrides, borides and carbides of these materials.

The oxide forms of the CAP do not need to be coated with additional ceramic material and are thus are used in the preferred embodiments of the invention. The other CAP materials can be coated with fission product and hydrogen tight coatings of silicon carbide or a corresponding ceramic from the matrix alloys. For example, plutonium nitride could be capped with aluminum zirconium nitride. This application and disclosure advances the art of inert metal matrix alloys and not coatings for CAP or MAP.

All CAP materials or MAP materials with or without fertile actinide hydrides are dispersed homogeneously in the selected inert metal matrix alloy. The matrix alloy is comprised of varying percentages of aluminum, vanadium, nickel, and/or zirconium depending on desired reactor operating temperature and the desired neutron spectrum. The coatings for CAP materials function as primary fission product barriers and the selected inert fuel matrix functions as the secondary fission product barrier. The outer part of the fuel assembly matrix is preferably clad with zirconium alloy, an oxide strengthened nickel aluminum alloy, and an oxide strengthened chromium steel alloy or HT-9 depending on the coolant selected and the temperature range most suited for the application. This cladding is the tertiary hydrogen and fission product barrier.

When CAP in oxide forms is selected, coatings are optional. The primary fission product receptacle is the oxide itself. The matrix metal is selected in the first fission product barrier and hydrogen barrier and the exterior cladding is selected in the second barrier for hydrogen and fission products. Some phosphorus can be added to entrap xenon gasses as aluminum phosphate traps this fission product gas well.

The fertile actinide, thorium, is enriched with fissile Uranium 233 or 235 or reactor grade Plutonium or other fissile actinide fuel and is combined so that the fuel is a finely powdered oxide, carbide, nitride, boride or silicide (CAP, a ceramic actinide particle) that is dispersed in particle form throughout the volume of the inert fuel matrix alloy selected comprised of either nickel-aluminum-zirconium, for fast or epithermal applications or vanadium-aluminum-zirconium, for thermal applications. Any carbide fuel particles must be coated with silicon carbide because uranium carbide can react with nickel alloys.

The other embodiment class uses MAP instead of CAP. These are metallic actinide particle grains that are dispersed in the selected metal matrix. These need a coating to provide a primary fission product and hydrogen barrier. The coating for this embodiment is a shell of oxide, nitride, silicide, boride or carbide. The coated MAP are dispersed and the fuel assembly is clad. This embodiment will find application in test and experimental reactors that should no longer rely on heavily enriched uranium as a fuel.

The percentage of enrichment of the fertile actinides with fissile actinides is determined by the design features of the reactor such as power density, refueling period, reactivity coefficients, and breeding ratio, which define the core dimensions and which consequently specify the level of fuel enrichment with fissile CAP or MAP in fertile CAP or MAP. To enhance non proliferation the fuel is denatured with uranium 232 and proactinium 231 along with any other uranium isotopes, using as little uranium 238 as possible. The fuel will produce uranium 232 and proactinium 231 in reasonably sufficient quantity providing the neutron spectrum is hard enough and the flux high enough so as to produce a radiation shield for the fuel to discourage proliferation of the fuel. Further, the fuel will contain other uranium isotopes including quantities of uranium 238 to “denature” the fissile uranium isotopes rendering them difficult to purify to a concentration having reasonable size and explosive potential.

The preferred embodiment uses oxide CAP. The oxide group of CAP does not need any coatings. Thorium oxide has excellent high temperature properties. Thorium oxide is chemically inert for the most part. Thorium oxide can be fabricated to have a density of approximately 85% of theoretical maximum. This allows thorium oxide to have plenum space for fission product gasses and for expansion to counteract fuel swelling effects that would otherwise become troublesome as the percentage of fission product oxides increase in the oxide CAP over the life of the core. For thorium oxide, the fissile material choices include: uranium 233 oxide, uranium 235 oxide or oxides of reactor grade plutonium or any combination of these.

The NAZ and VAZ alloys were selected because of their mechanical and neutronic properties. NAZ is used for non-thermal applications and VAZ is for thermal applications. The neutron capture cross section for aluminum is 0.00298 barns. For zirconium it is 0.03012. For nickel it is 0.03516 and for vanadium it is 0.02745. The capture cross section for nickel in the fast spectrum is less. Nickel is included as part of the fast spectrum alloy because it scatters the neutrons to provide a neutron trapping medium in the matrix. Nickel is excluded from the thermal spectrum alloy formulation because it will capture too many neutrons. zirconium, aluminum and vanadium form stable high temperature hydride alloys.

Zirconium and aluminum are included as ingredients of the alloy for all spectrums because of the beneficial properties of the hydride of this alloy. Aluminum is included as an ingredient of the alloy for all spectrums because it has a low neutron capture cross section and is very transparent to neutrons having energies in the fast to epithermal spectrum needed for the transmutation and fissioning of the heavy metal components or transuranic components of spent light water fuel: plutonium, neptunium, americium and curium.

Computational research has established that for one embodiment of a compact core design having a diameter of 140 centimeters and a height of 50 centimeters, the ratio of uranium 233 oxide UO2 to thorium 232 oxide ThO2 is very close to 11.5% for fissile uranium 233 (uranium 233>93%) and 88.5% for fertile thorium oxide. The fertile thorium can be denatured with scant amounts of fertile uranium 238 and with some uranium 232 at the outset and some proactinium 231 could be used as a burnable poison. The presence of uranium 232 and its continuous production along with the uranium 233 provides a denaturing function so the uranium 235 used as a starter and the uranium 233 produced in the reactor is not suitable for illicit diversion to weapons applications because the uranium 232 provides a shield of penetrating gamma radiation from its decay products and in order for the fissile uranium to be concentrated to that needed for the fabrication of explosives, the uranium 233 and 235 need to be isotopically separated from the uranium 232, 234, 236 and 238 present in the core as the fuel is deeply burned. Because the fissile isotopes or uranium are mixed with non-fissile isotopes of uranium, there is a barrier engineered into the fuel in addition to the radiation barrier making the uranium produced in the core unsatisfactory for use in weapons assuming the uranium could be separated from the fuel in the matrix of metal and ceramic after it was removed from the core.

For the same sized core, computations showed for another embodiment the ratio of reactor grade plutonium oxide to thorium oxide very close to 21.25% reactor grade plutonium to 78.55% fertile thorium oxide. Again the thorium can be denatured with modest amounts of uranium 238 and uranium 232 so that the uranium 233 produced in the reactor is not suitable for diversion to weapons applications.

For the same sized core, computations for another embodiment showed a ratio between heavily enriched uranium oxide 23.41% (uranium 235>93%) to thorium oxide 76.61%. This combination of starter fuel produced results showing satisfactory neutron chain reaction and satisfactory transmutation of thorium to uranium 233 for long term core life.

The least amount of uranium 238 is always the preferable alternative so that the reactor will produce as little plutonium 239 and 240 as possible and the use of uranium 232 grown in the core along with uranium 232 produced enhance the non-proliferative benefits of this fuel in matrix. The nuclear fuel of the present invention permits design of compact nuclear reactors able to more efficiently convert thorium 232 to uranium 233 and to fission the uranium 233 produced while also simultaneously producing process heat and electric power over a longer time period than existing fuels because the fuel grains are within the inert metal matrix that conducts heat well, has a high melting temperature and has low parasitic capture of neutrons. The inventive fuel assemblies are thus suitable for the production of heat for electric power or process heat or both while producing and consuming uranium 233. The fuel and the reactor can be configured to dispose of minor actinides and plutonium by neutron irradiation and transmutation and to “fission away” these undesirable elements.

The fuel assemblies disclosed herein are designed to have a negative fuel temperature reactivity coefficient and to have selected temperature thresholds as an autonomous reactivity control mechanism. The core life is ten years to fifteen years or more without refueling or fuel shuffling for the fast core powered by uranium 233 oxide from the outset.

This invention advances the art relating to the use of hydrides with ceramic fuel particles or metallic fuel particles dispersed in aluminum alloys to exploit neutron spectrum softening effects in the context of a fast reactor to convert fertile thorium to fissile uranium 233 more efficiently so that enough uranium 233 is produced in the fuel so that it can be burned more deeply, that is, for a longer time. The invention discloses a new set of inert fuel matrix alloys to materially advance the art of nuclear power production by providing cleaner burning fuels and a practical means to eliminate plutonium and other wastes from spent light water reactor fuels.

Thorium is featured as the fertile nuclear fuel material and isotope target assembly material because the thorium fuel cycle is less proliferative and produces far less plutonium and minor actinides than the uranium 235/238-plutonium fuel cycle does. Further, thorium is about 3-4 times more abundant than uranium and does not need to be isotopically separated as uranium must be. Because the amount of uranium 238 is kept as low as possible when uranium 232 and uranium 233 are produced in thorium in situ, less plutonium is produced in this thorium fuel cycle, the uranium 232 providing a radiation barrier protecting against proliferation.

Turning now to other uses for the alloys, the production of commercial and medical isotopes is considered. Many isotopes are produced as either capture product isotopes or fission product isotopes. Presently molybdenum-99 that decays to technitium-99m is the most used medical isotope. It is produced in target assemblies by fissioning heavily enriched uranium and the resulting molybdenum-99 is a fission product that is chemically separated from the other fission products. It is desirable to develop alternate methods of production for this medical isotope and others that are produced from fission products because the heavily enriched uranium used to produce the fission products could be diverted and used for illicit purposes. Molybdenum-99 can be produced in the fast neutron spectrum from molybdenum-98 by capture. This isotope comprises approximately 24.10 percent of terrestrial molybdenum. This isotope is concentrated by technical means and is fashioned into a foil. A separate foil of thorium and fissile uranium or of fissile and fertile uranium is rolled up with the enriched molybdenum foil and placed into a tube comprised of NAZ. This tube is irradiated by thermal neutrons. The fissile uranium in the foil fissions, functioning as a neutron multiplier and produces hard or energetic neutrons and fission products. The enriched molybdenum foil captures fast spectrum neutrons more efficiently than thermal neutrons. The product isotope molybdenum-99 is produced and is available for use for medical applications making its decay product as technitium-99m available for market. Other isotopes of interest are selenium-75, holmium-166, iodine-125, yttrium-90 copper-64, copper-67, lutinium-177 and tungsten-188. These can be produced analogously in the fast spectrum, the respective targets being foils or imbedded grains of selenium-74 or arsenic-74, holmium-165, tellurium-130, zinc-66, yttrium-89, copper-65, ytterbium-176 or tungsten-186.

The target assemblies would be formulated so that spectrum tailoring could be used to produce rhenium-188, for example. Here the starting material is tungsten-186 and this isotope must capture two neutrons to make tungsten-188 which decays to the desired rhenium-188. The tungsten must be exposed to a high neutron flux in the epithermal spectrum for the two captures to occur with sufficient frequency. This is accomplished by use of the modified nickel aluminum zirconium vanadium alloy (sometimes referred to herein as “NAZV”) alloy formulated with hydrides to tailor the spectrum to the most advantageous spectrum. This NAZV alloy can be made into a hydrided foil and rolled up with the enriched uranium foil and the target foil so as to tailor the neutron spectrum.

It is therefore an object of the present invention to provide a new and improved non proliferating nuclear fuel.

It is another object of the present invention to provide a new and improved inert metal matrix alloy for thorium converter reactors.

A further object or feature of the present invention is a new and improved alloy formulation for medical isotope production.

An even further object of the present invention is to provide a novel fuel for test and experimental reactors.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the international, regional, and national patent office(s) and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted. scope of the present invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is top cross-sectional view of a thorium converter reactor of this invention showing the inventive compact core 110, reflector 110, heat pipes 120, and lattice cells 180, this view taken along section line 1-1 of FIG. 2;

FIG. 2 is a cross-sectional side view in elevation of a thorium converter reactor showing the compact core, heat pipes or thermo siphons 120, and boiler or thermal reservoir above 140 and below the compact core 180, this view taken along section line 2-2 of FIG. 1;

FIG. 3 is a view of a few lattice cells showing an inert metal matrix alloy and oxide fuel elements as lattice cells 180, heat pipes 170, and mercury vapor coolant inside the heat pipe 130;

FIG. 4A is a top cross-sectional view of an alternate embodiment of the invention illustrating a central void region 150, and a pattern of the placement of the fuel assemblies 200, a reflector 230, a radial liquid thermal reservoir 240, and a jacket 250, this view taken along line 4A-4A of FIG. 5;

FIG. 4B is a further top cross-sectional view of the alternate embodiment of FIG. 4A, this view taken along line 4B-4B of FIG. 5, illustrating the central void region 150, the pattern of the placement of fuel assemblies 230 and the thermo siphons 220 that have increased ability to transport heat, the reflector 220, and the jacket 250;

FIG. 5 is a cross-sectional side view of the alternate embodiment of FIG. 4 illustrating the central void region for control 150, fuel assemblies 200, thermo siphons 220 showing the reflectors 230 and solid thermal reservoirs 230, and a radial liquid thermal reservoir 240; and

FIG. 6 is a cross-sectional side perspective view illustrating a target tube assembly of the alloy, showing the production of a desired medical isotope such as molybdenum-99 by neutron capture in the fast spectrum by molybdenum-98, and further illustrating a cut away of the driver tube 300 containing fissile material in the alloy in ceramic or metallic form and the rolled molybednum-98 target foil 360 inside a tube of the alloy, nickel-aluminum-zirconium, that provide spectrum tailoring or shaping function between driver tube 300 and target foil 360.

### BEST MODE FOR CARRYING OUT THE INVENTION

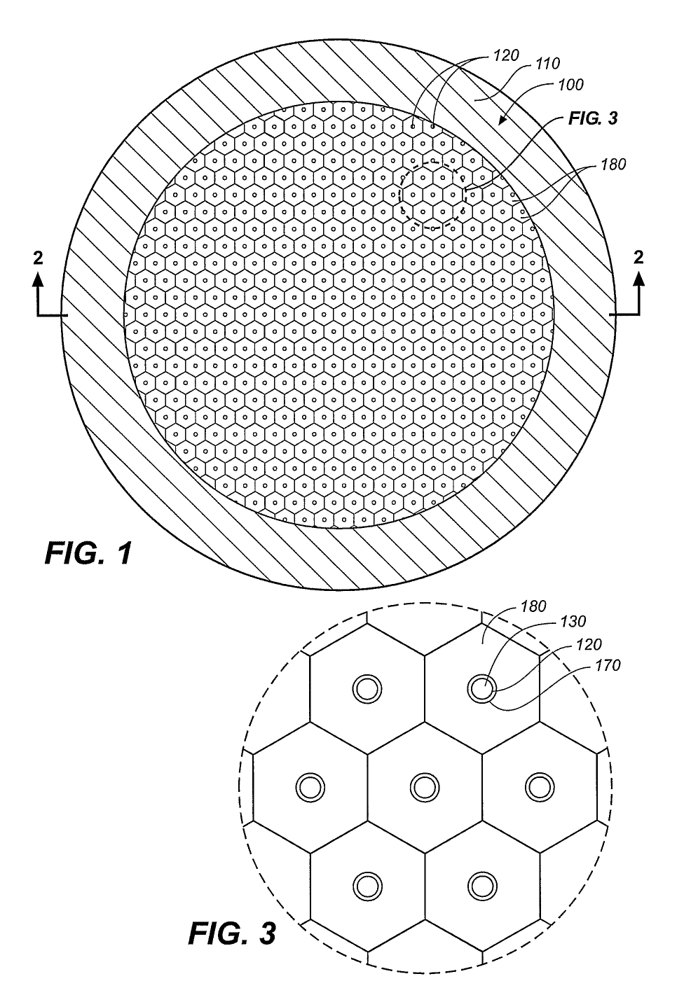

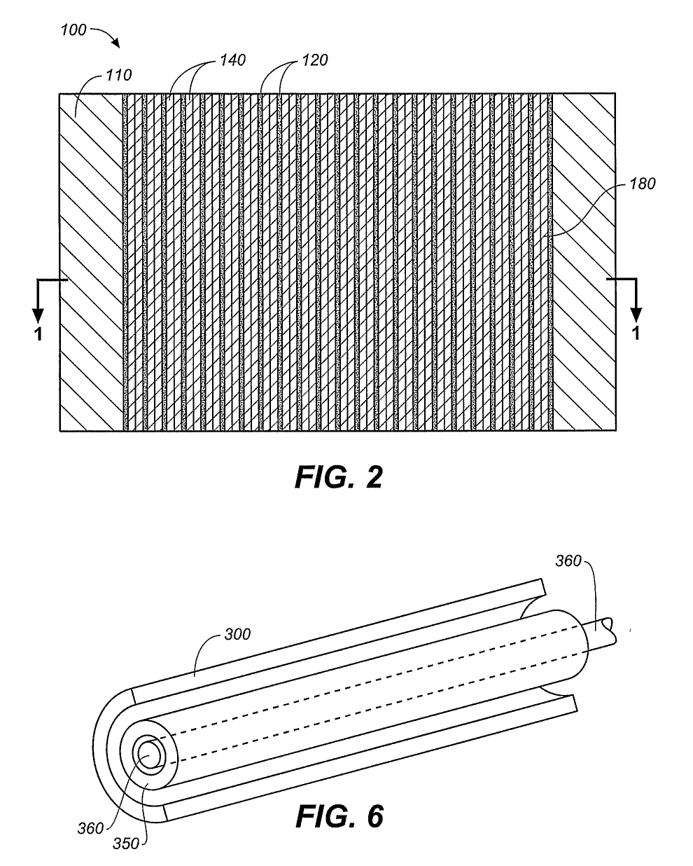

Referring to FIGS. 1 through 6, wherein like reference numerals refer to like components in the various views, there is illustrated therein a new and improved inert metal matrix to hold or contain particles of non-proliferating thorium nuclear fuel in CAP or MAP form and a fast spectrum thorium converter reactor utilizing the same.

FIGS. 1-3 together show the inventive thorium converter reactor designed to operate at a steady state power range of ˜50 Megawatts thermal at a temperature of ˜400 degrees C. with cooling accomplished by heat pipes that transfer heat to an intermediate loop and/or a power conversion system above the core. The structural elements of the core are fabricated where practical from nickel-aluminum, zirconium-aluminum, vanadium-aluminum or nickel-zirconium-vanadium-aluminum, similar to the inert metal matrix comprising the fuel assemblies or low capture alloy of iron and nickel. The heat pipes or thermo siphons are fabricated from ferritic martensitic steel, or oxide dispersion strengthening (ODS) martensitic steel, or HT-9, and are integrated with the fuel elements in all configurations to receive heat from the fuel and to transmit it to the working fluid in the heat pipes. The working fluid inside of the heat pipes delivers the heat to the boiler area or thermal reservoir above the core by means of liquid to vapor phase change, the return liquid transport is by capillary action and gravity. The working fluid selected for the temperature range of the preferred embodiment is mercury with alternates for other embodiments. The process heat or electric power circuits tap the steam generators in the boiler or thermal reservoir for the thermal energy that drives the turbines to produce electricity and provides the heat for the selected or desired process heat application such as desalinization of sea water.

The reactor has unique design characteristics. It is a compact reactor employing hydrides in the fertile/fissile fuel assembly to soften a fast neutron spectrum to an intermediate or epithermal neutron spectrum among the various embodiments of the invention. The resonances in the neutron absorption cross-section of thorium assist thorium to absorb neutrons when the fuel temperature is too hot for the embodiments designed for the fast or epithermal applications. The increase in temperature enhances the thermal kinetic energy of the nuclides in collision with neutrons so the resonances are broadened to fill up the valleys in between resonances (i.e. Doppler broadening effect). The Doppler broadening effect enhances the neutron absorption in the epithermal energies as the valleys in the resonances are filled up. The Doppler broadening effect also has a major effect on the prompt negative fuel temperature coefficient and ensures that the reactor has a good negative fuel temperature feedback to improve safety. Negative reactivity feedback is essential for the inherent safe operation of the reactor and this attribute allows for the novel fast reactor to operate autonomously.

The fuel assemblies are designed to take advantage of the resonances of thorium to enhance thorium capture of neutrons in the reactor core especially when the fuel is approaching the upper operating limit of the power conversion system. Thorium functions as the fertile material for uranium 233 because the neutrons are efficiently captured and absorbed by the thorium in epithermal energies. The ceramic actinide particles, CAP, are deployed in an invented inert metal matrix of “neutron traps” afforded by the nickel-aluminum-zirconium alloy or other nickel alloys such as nickel vanadium and nickel zirconium for the fast to epithermal reactor embodiment. For the thermal embodiment, nickel is excluded from the alloy and vanadium is utilized in its place as needed. The thermal spectrum alloy is vanadium-aluminum-zirconium so that the thermal neutron moderation requirements can be accomplished by the matrix alloy in whole or part. A large amount hydrogen or deuterium will remain bound in the matrix alloy even at temperatures above 0 degrees C. As the amount of hydrogen or deuterium is increased in VAZ, the vanadium-aluminum-zirconium-hydride and/or deuteride matrix gains ability to function as the primary moderator to thermalize the neutrons. The hydrided metal matrix assists neutron capture in thorium and permits escape of higher energy neutrons because the thermally caused movements of the hydrogen or deuterium atoms in the matrix will impart energy to neutrons to favor capture by thorium and to disfavor capture by uranium 233 or uranium 235 or plutonium 239.

The metal matrix in another fast neutron embodiment is composed of nickel aluminum zirconium or nickel aluminum zirconium vanadium alloy that has been optimized for thorium conversion and reactivity feedback. This matrix alloy is designed for elimination of plutonium. Its ranges of materials are approximately 30%-50% aluminum, 30%-50% nickel and 5%-30% zirconium and 5%-30% vanadium or as otherwise shown with greater particularity on the accompanying charts. Aluminum has low parasitic neutron absorption cross-section, and nickel has a high elastic scattering cross-section to trap neutrons in the core. This fuel matrix has large valleys in the elastic scattering cross sections at higher neutron energies. These features promote more effective burning of minor actinides, allow lower initial fissile material loading, and permit a compact core design. The other metals of the alloy, vanadium or zirconium have similar neutronic properties so these can be added to improve neutronic behaviors in the matrix when the desired spectrum is in the thermal range when these metals are substituted for nickel.

The hydrogen atoms in the hydrided fuel designed for a fast or epithermal reactor do not function the same way as in the TRIGA reactor. In a TRIGA the warm neutron effect predominates as a safety feature when the neutron population is too high. There the zirconium hydride or the thorium hydride interacts with the neutron population by adding energy to the neutrons so as to keep their energy above that needed for capture by fissile uranium 235. The heat of the fuel in the TRIGA has high negative reactivity because the hydrogen atoms provide energy to the neutrons so as to deprive the fissile material of neutrons at the appropriate spectrum to sustain increasing reactivity or power from the core.

The function of the hydride in the nickel aluminum zirconium alloy for fast neutron spectra applications is to soften the neutron spectrum to an optimal form or shape for reactivity control, waste incineration and breeding of fertile materials or if waste incineration is not the primary function of the reactor, to extend core life by maximizing breeding of uranium 233 from thorium 232. The addition of a small amount of hydrogen to this NAZ alloy exploits the Doppler broadening effects so that thorium will be a much better neutron absorber when temperature conditions are elevated.

The present invention advances over the prior art as the inventive non-proliferating fuel matrixes can be adapted for use in a fast reactor that converts thorium to uranium 233 while simultaneously producing power or heat or both. The hydride fuel is contained under “hydrogen-tight seal” caused by the property of zirconium aluminum hydride or vanadium aluminum hydride to function in high temperatures. Hydrogen and fission product gasses are kept from escaping the fuel matrix as zirconium aluminum with various differing zirconium and aluminum ratios acts as hydrogen barrier or high temperature hydrogen absorber in the event temperature and pressure conditions allow for hydride dissociation in the fuel. Further, addition of aluminum phosphate will entrap xenon gasses and this is a recommended option for control volumes such as rods or safety rods. The actinide carbide or other non-oxide particles are coated with pyrolytic carbon and/or silicon carbide and are dispersed in an inert metal matrix of nickel-aluminum-zirconium. The hydride fuel and coated carbide or uncoated oxide fuel particles may be dispersed in an inert metal matrix of aluminum-zirconium-nickel-vanadium or combination of two or three or four of these elements as alternative embodiments depending on the neutron spectrum desired.

Because the hydride's hydrogen atoms are in physical contact with the fissile and fertile materials in the fuel configurations for thermal, epithermal and fast spectra, the temperature of the thorium hydride/deuteride matrix influences, to some extent almost instantaneously, the rate of fission in the fissile material in the vicinity of the hydride/deuteride matrix.

Further, erbium or other lanthanide functions as burnable poison to capture neutrons to compensate the excess reactivity at the beginning of life (sometimes referred to herein in “BOL”) of the reactor. An additional burnable poison is proactinium-231. The addition of an actinide or lanthanide burnable poison as hydride or oxide to the fuel allows a higher burnup and a longer refueling cycle.

Neutron reflection is provided by the external reflector material located above and below and around the circumference of the core. Neutrons leaked from the fuel elements may diffuse and be reflected back into the core by the reflector. The reflector material is comprised of oxide strengthened nickel-iron-chrome alloy similar to inconel or monel behind the thorium oxide jacket.

The core is cooled by heat pipes or thermo siphons which feed heat to a thermal reservoir above the core. The thermal reservoir is linked to an intermediate loop or a low-pressure boiler in the preferred embodiment. When molten salt or eutectic salts are used as a heat sink, this hot liquid is the thermal reservoir material into which the steam generators are placed.

The heat pipes or thermo siphons and structural elements for the boiler or heat reservoir area are constructed from HT 9 or other high chrome steel and other suitable high temperature steel alloy depending on the secondary coolant and its operating temperature. If water is the secondary coolant, the cold end of the heat pipes is coated or clad with another type of material that is more compatible with water. If the secondary coolant is an organic coolant, the pressure vessel of the boiler can be thinner and may reduce the total system cost. The fuel is clad in HT 9 or ODS steel and held in a structure of alloy similar to that of the fuel's matrix. The working fluid inside the heat pipes is mercury, TiCl₂F₂, sodium, lithium, or another mix of halide salts. To equalize heat distribution in the regions of the core nearest the “hot” ends of the heat-pipes or thermo siphons, liquid metal such a gallium should circulate by use of magneto-hydrodynamic pumps. The wicking material inside of the mercury heat pipes is steel with low nickel content. In other embodiments the core is cooled by light water, heavy water, liquid sodium or liquid metal eutectics such as lead bismuth.

A neutron generator is inserted under the core at start-up. This neutron generator is similar to other neutron generators developed at the Lawrence Berkeley National Laboratory. In the preferred embodiment the neutrons will be produced from a deuterium plus deuterium fusion reaction. When the reactor becomes critical, the neutron generator is removed. To scram or to shut the reactor down, neutron absorbing materials in the control rods and the safety rods are inserted into the core. Neutrons are captured in quantities by these rods to keep the reactor sub critical after shut down.

The reactor safety is increased by automatic control system. This safety control system is activated if temperature thresholds are passed. Heavy neutron-absorbing materials are inserted into the core by gravity. In one embodiment, tungsten and holmium shot which absorbs fast neutrons, enters the core from a compartment located above the core after a fusible alloy melts at a set temperature, releasing plug so that a large volume of tungsten and holmium shot travels down the central void in the core by gravity.

There are several advantages of the thorium converter reactor which makes use of thorium-uranium oxide, carbide, nitride or silicide particles in an inert metal matrix comprised of aluminum, nickel, vanadium and/or zirconium.

First, thorium produces comparatively little plutonium and minor actinides when uranium 233 is the bred fuel and uranium 238 is absent from the fuel. The spent fuel contains considerably less minor actinides and plutonium than the comparable spent fuel produced from the uranium 235/238-plutonium cycle would contain.

Second, thorium is monoisotopic and does not need to be enriched as natural uranium does. The uranium 233 that is produced in the reactor can be denatured by uranium 232 and scant quantities of uranium 238. Uranium 232 can be fed into the reactor fuel again after being separated from the fission products in the spent thorium fuel. Uranium 233 is burned in situ as it is produced. This is nonproliferative use of thorium.

Third, Tl-208 is an intense gamma emitter produced as a daughter product in the decay chain of uranium 232 and thorium 231. This high-energy gamma emitter provides a radiation shield that provides a deterrent to wrongful diversion of spent thorium fuel. Further, the gamma emissions provide a strong signal enabling existing instruments to track any improper movements of spent thorium fuel. Uranium 233 or 235 is provided with uranium 238 and uranium 232 and proactinium 231 as a burnable poison as needed at start up. The concentration of fissile material is below proliferation thresholds as the uranium isotopes, 232, 234, 236 and 238 provide important synergistic denaturing functions making the fuel unsuitable for explosive uses without separation of the uranium isotopes which given the presence of uranium 232 require expensive automated shielded facilities beyond the means of sub nation state proliferators.

Fourth, being compact, the core can be contained in a small, unitized vessel so the entire assembly can be fabricated in the factory environment and transported for installation in the field at the customer's place of business. This allows all of the fissile material to be installed and removed in the factory environment and not in the field. This approach reduces the risk of wrongful diversion of fuel as the core, jacket and pressure vessel are one unit. This approach is more cost efficient than large-scale construction of power stations of thousands of megawatts.

Many variations upon the preferred embodiments are possible. The simplest and most straightforward embodiment of the fuel assembly is as follows.

The primary fuel element is comprised of very fine particles of thorium 232 and uranium 233/238 oxide that are not coated. There is a small weight fraction of erbium oxide or proactinium 231 oxide for excess reactivity control at the BOL. The uncoated, fine fuel particles are dispersed in a nickel aluminum zirconium matrix, together with a small quantity of hydrogen or deuterium to soften the neutron spectrum. This matrix is designed for long term use in a fast to epithermal neutron spectrum.

An alternate inert metal matrix employs vanadium aluminum zirconium alloy instead of nickel aluminum zirconium. The uncoated, fine fuel particles of thorium 232 oxide and uranium 233/238 oxide are dispersed in the matrix along with the selected burnable poison together with increased quantities of hydrogen or deuterium so that the hydrided alloy replaces some or all of the light water used as a moderator to thermalize neutrons. This alternate matrix alloy is suitable for use in thermal spectrum reactors.

The fuel assemblies are made into two configurations one, the primary, enriched with fissile material to not more than the non proliferation protocols and best operating practices and the other the secondary is enriched with fissile material to a range less than that of the primary. The fissile material of the primary is more concentrated than that of the secondary. However, if the fast spectrum is the spectrum of choice, nickel aluminum zirconium is indicated as alloy constituents for the matrix. Similarly, for the thermal embodiments, vanadium aluminum zirconium is indicated as alloy constituents for the matrix.

The fuel elements with different enrichment levels are loaded in an alternating concentric or checker board patterns to minimize the power peaking factors in the core.

When the fuel assemblies are heated to the predetermined temperature thresholds by fission neutrons, the probability for chain reactions decreases so the rate of fission in the core declines. Various neutronic effects depending on the embodiment act to reduce the rate of fission after the temperature of the core increases to a temperature over the normal temperature range for the power conversion system. In the fast to epithermal embodiments, the Doppler broadening effects, caused by the heated thorium 232 and heated uranium 238 provide reduced rates of fission as temperature increases above normal operating temperatures. The hydrogen in the hydride fuel (or deuterium) is present to soften the spectrum to obtain a large negative fuel temperature reactivity feedback.

The inclusion of erbium with proactinium 231 in the core or in small trace amounts in the fuel as a burnable poison allows for a higher initial fissile fuel loading and allows having a longer fuel cycle so that the higher burn-up can be achieved.

It will be appreciated that the fast reactor uses thorium, uranium and lanthanides deployed in a compact core to provide fission heat over a long period of service from the efficient conversion of thorium to uranium 233. The fuel assembly configurations are designed to convert thorium to uranium 233 efficiently and to passively maintain the temperature of the core below 450 degrees C. during the core's decade long service life in the field.

Control rods and safety rods are present inside of the as a safety feature and to provide the means to shut the reactor down. These rods are comprised of neutron reflectors on one end and absorbers such as boron 10 carbide or cadmium, hafnium, or indium to capture thermal neutrons and tungsten holmium and/or tungsten gadolinium to capture fast neutrons. When the rods are in the core, neutrons are absorbed and are removed from the core permanently. Other control features include the automatic injection of tungsten-holmium shot oblate spheroids (the “M&M” shaped tungsten holmium BBs) into the void volumes of the core as a temperature threshold is passed melting a fusible alloy which opens the shot feed tube above the core.

The fuel assemblies in all configurations as rods, plates, disks, bars, coils, tubes contains at least two actinide elements, such as fertile thorium 232 and fissile uranium 233, a lanthanide, or combination of lanthanides such as erbium, dysprosium or holmium for surplus reactivity control. In addition to the above mentioned fertile and fissile actinides and lanthanides in various proportions, hydrogen or deuterium is added to form metal hydrides or deuterides of the actinides or hydrides or deuterides of the matrix alloy for an enhanced neutron spectrum shaping so that neutrons are either captured more efficiently by thorium for conversion to uranium 233 when the fuel temperature is above the normal operating temperature or so that the thermalised neutrons are fissioned by uranium 233 when the fuel temperature is near or below the normal operating temperature. These effects make thermal neutrons comparatively scarce when the fuel is hot so that fission of either, uranium 233, uranium 235 or plutonium 339 is discouraged when the fuel temperature is above normal operating temperature since neutron capture by thorium becomes increasingly more likely at elevated temperatures.

An additional safety factor is the fusible aluminum or gallium aluminum “cork” or membrane. Aluminum melts at 645 degrees C. so it can function to passively allow the passage of fast neutron absorbing tungsten alloys into the core when the melting temperature is reached and the aluminum cork melts to release the shot into the core. The tungsten shot rests above the fusable alloy cork and the shot drops to the core under the force of gravity when the “cork” melts.

One novel additional aspect of this design is that the nuclear fuel delivers heat to liquid gallium, mercury or sodium or other working fluids delivering the heat to heat pipes or thermo siphons enclosing a selected working fluid to transport the heat by vapor transport to the boiler/reservoir above the core. The heat pipes or thermo siphons function in a coordinated group without moving parts each individually and passively transporting heat with a high efficiency. Because one single heat pipe failure will not compromise the safety operation of the whole system, the reactor has a redundant cooling system as the heat pipes work as an adjunct to the other liquid coolant selected.

If the fuel temperature exceeds the disassociation temperature, the release of hydrogen or deuterium to the core from thorium hydride or zirconium aluminum hydride in the matrix is blocked by the zirconium-aluminum matrix that acts an integral coating and a reliable hydrogen barrier. (The dissociation temperature of thorium hydride is about 883 degrees C. at one atmosphere, for zirconium it is lower but when aluminum is present the hydrogen gas stays entrained in the zirconium aluminum matrix in temperatures considerably above 883 degrees C. to a range of 1100 degrees C. or so. This is well above the 450 degree operating temperature of the reactor.)

The design uses heat pipes or thermo-siphons in contact with liquid metal in contact with the fuel assemblies in many of the configurations to transfer and deliver heat from the inert metal matrix containing fuel to transport heat to the liquid metal, molten carbonate, molten salt or light water or heavy water or organic fluid “boilers” outside and above the core. This “boiler” area functions as a thermal reservoir providing the heat to produce pressurized vapor for the electric power generation circuits or to provide heat to the working fluids for process heat circuits.

This reactor can burn fuels partly recovered from spent light water reactor fuel. The fuel ceramics can use minor actinides and isotopes of plutonium in oxide, nitride, silicide or carbide form for use in the fuel matrix partially or totally in place of uranium 233 or 235 as the initial fissile component of the fuel assembly with the hydride or deuteride for spectrum softening and the lanthanide components added to allow for higher burnup. Thorium assists plutonium elimination because it, unlike uranium 238, does not accumulate enough neutrons produce significant quantities of plutonium. In designs where the major purpose of the reactor is the elimination of plutonium, little or no uranium 238 should be included in the fuel mix. These reactors should be operated only in a secured and guarded environment.

Turning to FIG. 6 an alternative use of the NAZ alloy is depicted. Here the diagram depicts two foils rolled up together. One driver tube 300 contains fissile uranium 235 or uranium 233 in metallic form. The other foil 360 contains molybdenum-98. The rolled together foils are placed in a tube of VAZ/NAZ engineered for this application. The tube is irradiated with thermal neutrons. These pass through the tube and interact with the fissile material in contact with the target alloy. There is fission and the fission spectrum neutrons are captured in the foil containing the target isotope separated by an engineered matrix alloy of NAZ or VAZ in foil or plate form in a selected geometry to tailor or shape the spectrum to maximize transmutation in the target to the desired isotope. If there are too many neutrons this surplus is controlled by the presence of thorium that is in foil form on the interior of the tube. This target assembly is designed to make use of the alloy, and is discussed to show other uses or applications of the aluminum alloys disclosed herein.

The Nonproliferative Fast Neutron Spectrum Thorium Nuclear Reactor: Nuclear energy can be made more sustainable as an important energy resource for the world by use of the thorium fuel cycle. Thorium is a cleaner energy source material than uranium because spent thorium fuel will not contain significant amounts of transuranic elements: neptunium, plutonium, americium or curium because the original thorium fuel will contain scant amounts of uranium 238. This makes the thorium fuel cycle more sustainable than the uranium plutonium fuel cycle because spent thorium fuel has no explosive potential, unlike the spent fuel used in the uranium-plutonium fuel cycle. Importantly also, is the fact that the toxic radioactive decay products from thorium fission generally have much shorter half lives than the transuranic elements produced in the uranium-plutonium fuel cycle. Because the thorium waste footprint is significantly shorter lived and significantly “smaller” lacking the transuranics, fission of thorium fuels provides an important alternative to fission of uranium fuels. Thorium oxide has an additional advantage. When it is combined with weapons grade or reactor grade plutonium oxide, fertile thorium can be used to efficiently eliminate fissile plutonium and to transmute the long lived transuranic elements present in spent light water reactor fuel. The thorium fuel cycle has dual beneficial attributes: lower cost and cleaner energy production. The cost is lower because thorium is more abundant than uranium and thorium does not need to be isotopically concentrated or separated. Further, waste plutonium from light water reactors or surplus military plutonium can be combined with thorium to make a fuel for use in either a fast reactor or a thermal reactor. The fast plutonium burning reactor is preferable to the thermal reactor in some circumstances. The fast reactor can be designed to have a long core life so that the operator of the reactor need not refuel or shuffle fuel. The fast spectrum allows more conversion of the thorium and a deeper burning of the fuel. This means that more thorium can be transmuted to uranium 233 in the reactor core to maintain a controlled nuclear chain reaction for a longer time than is possible using the thermal neutron spectrum.

Turning now to the non-proliferative fast thorium reactor, the fuel of the preferred embodiment is thorium 232 oxide and uranium 232/233/238 oxide dispersed in nickel aluminum zirconium alloy. This core is 1.4 meters in diameter and 0.5 meter in height. The ceramic actinide portion of the fuel assembly varies depending on the volume of the core. Generally, the larger the volume of the core, the lower the needed minimum percentage of fissile material in the ceramic or the metal particles that are dispersed homogeneously in the alloy.

For the small, fast, compact embodiment having the 140 centimeter diameter and the 50 centimeter height, the percentage of ceramic to alloy metal by molecules is 33.33% metal alloy and 66.33% actinide ceramic particles. Thus, the lower range of the alloy is 33.33% and the upper range for the alloy/ceramic mix is 50%/50% as core volume is increased.

The alloy is nickel aluminum zirconium for this fast neutron embodiment. The content of the alloy by atomic ratio is: nickel 30%-50% aluminum 40%-60% zirconium 20%-30% and a trace of boron 11 and a trace of phosphorus 100-200 ppm dispersed in the alloy.

The actinide ceramic is finely powdered to constitute two thirds of the volume of the fuel assembly in rod, plate or coil form.

Study has shown that when uranium 233 oxide constitutes 11.5% and thorium 232 oxide constitutes 88.5% of the CAP, ceramic actinide particles, is dispersed homogeneously in NAZ the modeled small compact core maintains a critical chain reaction capable of producing enough additional uranium 233 to produce at least fifty megawatts of thermal energy for a long duration. With the addition of hydrogen or deuterium and a reduction of neutron leakage by reflection, the core could be configured into a modified geometry to have a reduced volume. The fissile uranium and fertile thorium and the selected denaturant uranium 232 or uranium 238 or a combination thereof are blended first. This is converted to oxide and then this is powdered combined with the alloy metals: nickel, aluminum and zirconium in a 40%/40%/20% ratio or as otherwise determined by computation. Traces of boron 11 are added along with engineered amounts of hydrogen or deuterium as metal hydrides in powder form. The volume of the thorium-uranium oxide is approximately 85% of theoretical maximum to provide a plenum for fission product gasses and to accommodate volume changes anticipated for a long core residence time. It is anticipated that most of the fission products will combine with oxygen and remain stable in the oxide particles within the metal matrix alloy. A small amount of aluminum phosphate is added to trap Xenon gasses produced as fission products and this is provided for control rods. To enhance long term reliability each fuel assembly is enclosed with a zirconium alloy tubing to provide an additional hydrogen barrier and fission product barrier. The exterior cladding exposed to the coolant is selected to be chemically compatible with both the zirconium under cladding and the coolant. For many coolants, HT-9 or HT-12 is the compatible material.

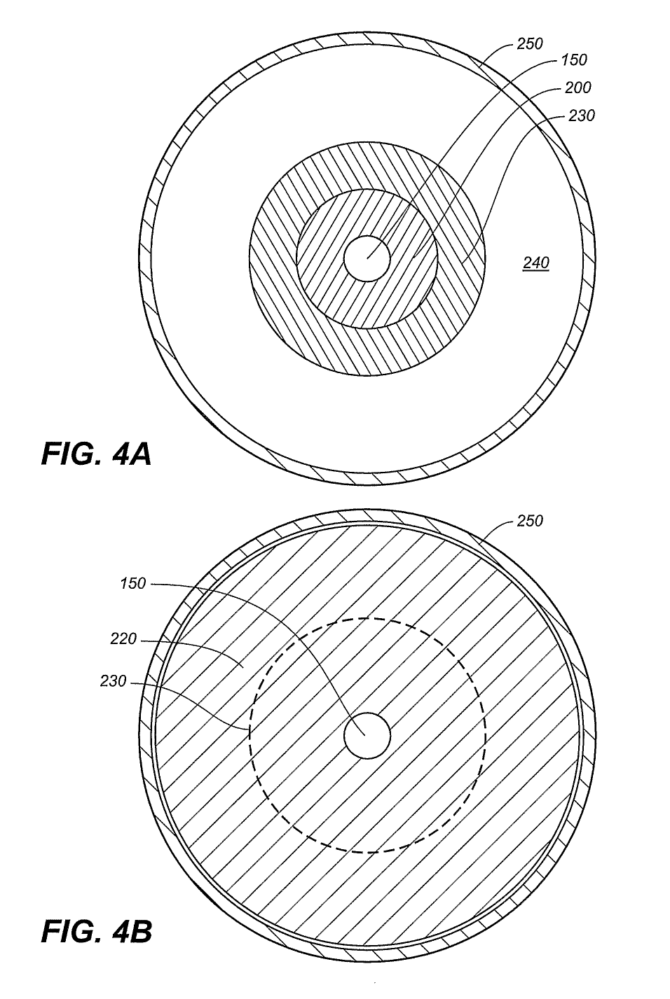

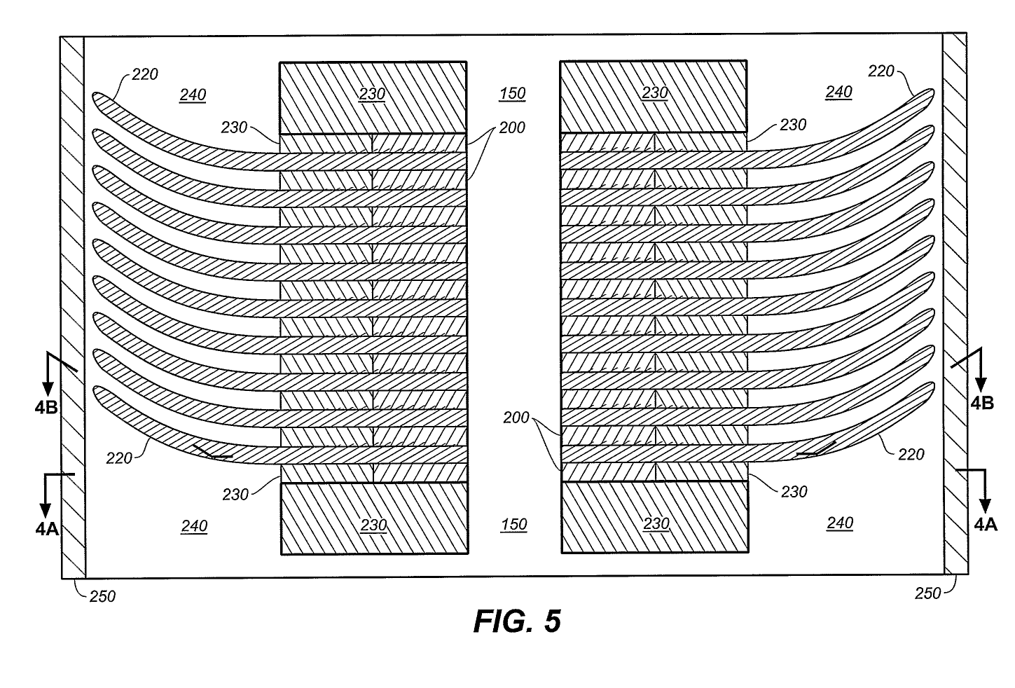

The fuel assemblies are immersed in a liquid metal such as gallium to enhance heat transfer between the fuel and the heat pipes or thermo-siphons so that each fuel assembly can provide heat to two heat pipes or thermo siphons. The array is hexagonal in many configurations but may also be in the “washer and bowl” assembly depicted in FIGS. 4(A) and (B) and FIG. 5 so that the heat pipes/thermo siphons are placed in contact with at least two fuel assemblies. Heat is managed by both the heat pipes and the liquid coolant. Both coolants circulate passively. The heat pipes function to assist the liquid coolant in heat transport. The liquid convects and transmits heat to the thermal reservoir.

The following embodiment deals with retrofitting any existing thermal reactor by means of CAP dispersed in VAZ (ceramic actinide particles dispersed in vanadium aluminum zirconium) This type of fuel plan employing thorium fuel plan can be adapted to existing light water reactors or for thermal spectrum reactors in the certification pipeline. Here the inert metal matrix is comprised of aluminum, vanadium and zirconium forty percent each for the first two and twenty percent for the last or as otherwise computationally modeled. The aluminum and the zirconium in this matrix are relatively transparent to neutrons and have low rates of parasitic neutron capture. When vanadium is substituted for nickel and nickel is excluded from this inert metal matrix, vanadium provides some scattering for the more energetic neutrons. Importantly, this matrix material provides an effective hydrogen barrier at the temperatures and pressures associated with the self regulating thorium fuel in a thermal neutron environment. VAZ is a stable a high temperature hydride. Aluminum zirconium is likewise a high temperature hydride. This alloy can retain hydrogen at temperatures greater than 1000 degrees C. When this alloy is hydrided to approximately one half of its absorption limit or deuterated to its absorption limit, the alloy functions as a moderator the hydrogen atoms behaving similarly to the hydrogen atoms in light water or heavy water when the fuel assembly system is not too hot. The neutrons will be effectively thermalised by the hydrogen in the fuel under the “seal” of the VAZ matrix alloy. Because there are numerous light water reactor designs, the hydride matrix that moderates can be used to provide longer core life in the larger core volumes originally designed for power applications using the uranium plutonium fuel cycle. Fewer neutrons will be lost to the light water moderator because the reactor's lattice and pitch array can be made to have less water volume between the fuel assemblies. The fuel will heat the metal matrix and this will be cooled by light water in existing pressurized reactor or a boiling water reactor designs. The thorium oxide fuel particles in the matrix alloy will be efficiently transmuted to uranium 233 as neutrons need not escape the matrix for moderation. The matrix alloy is compatible with hot pressurized water and steam and is a good transporter of heat from the ceramic particles to the working fluid. The fissile material in the matrix in one embodiment is uranium 235 oxide uranium 233 oxide or reactor grade plutonium oxide or a blend of them. The fissile component is combined with thorium oxide/hydride and is dispersed in the hydrided matrix of aluminum-zirconium and vanadium. The level of enrichment tracks that of the replaced fuel containing significant amounts of uranium 238 and uranium 232 with fissile enrichment usually in the range of 2.5% to 4.5%. The level of enrichment is a function of the reactor volume. The hydrided matrix permits a tighter lattice and tighter pitch than in the uranium plutonium fuel plan originally designed for the power reactor. The control features remain the same. The operating temperature remains the same. The fuel has an intrinsic safety factor engineered into it. The reactor will not lose its moderator if a loss of coolant event occurs and the core will not melt or otherwise damage the reactor because this feature can be avoided by system design incorporating or employing positive moderator temperature coefficients. The aluminum zirconium vanadium hydride will provide a moderator integrated into the fuel at a very high temperature. This thermal retrofit approach uses the aluminum zirconium vanadium matrix to hold and contain the dispersed oxides or other ceramic nuclear fuels: nitrides, borides, carbides, silicides or dispersed metallic fuel particles.

The following are examples of fuel assembly and alloy constituents (ratios by number of atoms, materials and percentage ranges for inert metal matrix by spectrum).

### EXAMPLE ONE

### Operating Range 350-450 Degrees C.

Fast Spectrum: inert metal matrix 17.5%-60% matrix alloy, balance actinide ceramic; fissile: U 235 22% to 24%+/−50%, U 233 10%-12%+/−50%, reactor grade pu 20%-24%+/−50%; Fertile: thorium 232 balance; aluminum 25%-50%, nickel 25%-50%, vanadium 10-20%, zirconium 10-20%, boron 11 100-200 ppm, hydrogen 10-1000 ppm +/−15%, or deuterium in twice the concentration. Actinide ceramics with lanthanide ceramic such as 0.1%-2% erbium oxide for reactivity control, proactinium oxide in amounts as needed for reactivity control and to produce uranium 232 denaturant. Reactor grade plutonium ceramic 21.5%+/−50% with corresponding thorium ceramic balance; or uranium 233 ceramic 11.5%+/−50% with corresponding thorium ceramic balance; or uranium 235 ceramic 23%+/−50% with corresponding thorium ceramic.

Intermediate epithermal spectrum: inert metal matrix 15%-55% matrix, balance actinide ceramic; aluminum 25%-45%, nickel 5%-35%, vanadium 5%-10%, zirconium 25%-45%, boron 11 100-200 ppm, phosphorus trace, hydrogen 100-10,000 ppm +/−25%, or deuterium in twice the concentration. Actinide ceramic same as above with lanthanide. Same percentages of fissile materials shown above.

Thermal spectrum: aluminum 25%-65%, nickel trace −0.4%, vanadium 10%-25%, zirconium 25%-50%, boron 11 trace, phosphorus trace, hydrogen 1000-100,000 ppm, actinide ceramic same as above. Ceramics include all actinide compounds as oxides, nitrides, silicides, carbides and borides. Fissile actinides concentration percentages vary by volume of core. As core volume increases, concentration of fissile material decreases.

### EXAMPLE TWO

### Operating Range 450-550 Degrees C.

Fast spectrum: inert metal matrix 17.5%-57.5% matrix alloy, balance dispersed actinide ceramic. Aluminum 25%-45%, nickel 35%-55%, vanadium 10%-15%, zirconium 15%-25%, boron 11 100-200 ppm, hydrogen 10-1000 ppm +/−15%, or deuterium in twice the concentration. Actinide ceramics: reactor grade plutonium ceramic 21.5%+/−50% with corresponding thorium ceramic balance; or uranium 233 ceramic 11.5%+/−50% with corresponding thorium ceramic balance; or uranium 235 ceramic 23%+/−50% with corresponding thorium ceramic.

Intermediate epithermal spectrum: inert metal matrix 15%-55% matrix, balance actinide ceramic. Aluminum 25%-45%, nickel 25%-30%, vanadium 2.5%-12.5%, zirconium 35%-55%, boron 11 100-200 ppm, hydrogen 100-10,000 ppm +/−25% or deuterium in twice the concentration. Actinide ceramic same as above.

Thermal spectrum: aluminum 25%-45%, nickel trace −0.25%, vanadium 10%-25%, zirconium 35%-65%, boron 11 trace, phosphorus trace, hydrogen 1000-100,000 ppm, or deuterium in twice the concentration. Actinide ceramic same as above. Ceramics include all actinide compounds as oxides, nitrides, silicides, carbides and borides. Fissile actinides concentration percentages vary by volume of core. As core volume increases, concentration of fissile material decreases. Ceramic means boride, silicide, nitride, carbide or oxide actinide compound. Corresponding means oxide of reactor grade plutonium is blended with thorium oxide, or uranium carbide is blended with thorium carbide, or uranium boride is mixed with thorium boride, etc. for nitrides and silicides. Boride means boron 11 compounds.

### EXAMPLE THREE

### Operating Range 550-650 Degrees C.

Fast spectrum: inert metal matrix 17.5%-57.5% matrix alloy, balance dispersed actinide ceramic. Aluminum 15%-35%, nickel 25%-45%, vanadium 2.5%-15%, zirconium 30%-55%, boron 11 100-200 ppm, hydrogen 10-1000 ppm +/−15%, or deuterium in twice the concentration. Actinide ceramics. Reactor grade plutonium ceramic 21.5%+/−50% with corresponding thorium ceramic balance; or uranium 233 ceramic 11.5%+/−50% with corresponding thorium ceramic balance; or uranium 235 ceramic 23%+/−50% with corresponding thorium ceramic.

Intermediate Epithermal Spectrum: inert metal matrix 15%-55% matrix, balance actinide ceramic. Aluminum 25%-35%, nickel 25%-30%, vanadium 2.5%-12.5%, zirconium 45%-65%, boron 11 100-200 ppm, hydrogen 100-10,000 ppm +/−25%, or deuterium in twice the concentration. Actinide ceramic same as above.

Thermal Spectrum: aluminum 15%-35%, nickel trace −2.5%, vanadium 10%-25%, zirconium 35%-65%, boron 11 trace, hydrogen 1000-100,000 ppm, or deuterium in twice the concentration. Actinide ceramic same as above. Ceramics include all actinide compounds as oxides, nitrides, silicides, carbides and borides. Fissile actinides concentration percentages vary by volume of core. As core volume increases, concentration of fissile material decreases. Ceramic means boride, silicide, nitride, carbide or oxide actinide compound. Corresponding means oxide of reactor grade plutonium is blended with thorium oxide, or uranium carbide is blended with thorium carbide, or uranium boride is mixed with thorium boride, etc. for nitrides and silicides. Boride means boron 11 compounds.

Just as fuel elements and reactor components make use of the alloys, so too can devices designed to produce medical isotopes in the fast, epithermal or thermal neutron spectra. The alloy provides a medium to scatter fast neutrons produced from fission reactions. Here the purpose of the alloy is not so much to transport heat from a reactor fuel, but is rather a matrix for fissile and fertile materials to act as a neutron multiplier to generate a hard, fast spectrum, that can be tailored or shaped by the addition of hydrides, oxides, carbides, nitrides or borides to optimize the neutron spectrum for the production of medical isotopes or commercial isotopes that are more efficiently produced in spectra faster or harder than the thermal spectrum. The alloys can hold the fissile particles as dispersed metals or as dispersed ceramic particles (MAP and CAP respectively) or enclose them as the tube depicted in FIG. 6 does. The neutrons produced by the fissions in the target assembly are more energetic than the thermal neutrons irradiating the assembly. The harder neutrons are needed to transmute precursor materials to useful and valuable medical and commercial isotopes. These assemblies can be placed into reactors having capabilities only in the thermal ranges. The assemblies function to boost the spectrum to a higher energy proximate and in contact with the target precursor materials selected. To control over-reactivity thorium 232 or uranium 238 is placed into the assembly to take up surplus neutrons when needed. Further, these assemblies should be engineered for safety reasons to be sub-critical. This way the assembly would have a K-eff of less than one, but near one, so as to provide a needed margin of safety for this novel means of producing isotopes.

Accordingly, the present invention may be characterized as one or more of the following:

The invention provides a novel nickel-aluminum-zirconium and vanadium aluminum zirconium alloy used as an inert metal matrix to hold dispersed ceramic actinide particles or dispersed metallic actinide particles in integrated a nuclear fuel assemblies to advance the non-proliferative aspects of the thorium fuel cycle. The various formulations of nickel aluminum zirconium alloys are for fast spectrum or epithermal applications. The various formulations of vanadium aluminum zirconium alloys are for thermal spectrum applications. The alloys hold dispersed ceramic actinide particles or metal actinide particles enabling a fast or thermal neutron spectrum that promotes uranium 233 production efficiencies allowing reactors to exploit the thorium fuel cycle. The alloys also have the attribute of being high temperature hydrides so that neutronic effects associated with hydrides can be advantageously put to use.

The invention also provides a novel nickel-aluminum-zirconium alloy and novel vanadium-aluminum-zirconium alloy for use as an inert metal matrix to hold dispersed particles of thorium containing ceramic or metallic fissile/fertile particles or grains for applications using fast and thermal neutron spectra being a fertile/fissile fuel mix comprising thorium, fissile uranium, fissile plutonium and a hydride or deuteride; and a selected lanthanide for use as a burnable poison in a contiguous locations and aluminum phosphate for xenon gas control; wherein the fertile/fissile fuel mix and the lanthanide need no coating as oxides but are under a coating or layering selected from the group consisting of borides, nitrides or carbides or silicides so as to create a coated fuel; and wherein all of the fine oxide particles or coated fine particles whether ceramic or metallic are dispersed in an inert metal matrix selected from the group consisting of nickel-aluminum-zirconium, vanadium-aluminum-zirconium, nickel, aluminum-zirconium-vanadium either as a binary compound or in any combination thereof with hydrogen added in the amount consistent with the neutron spectrum for the application, if at all.

The invention also provides a thorium-based non proliferative fuel for a power reactor as above, wherein the fuel mix is granular, that is having a larger particle size.

The invention also provides a fuel for thorium reactors designed to have negative reactivity feedbacks, especially negative fuel temperature reactivity feedback so that the self-control neutronics properties of the fuel make the reactor inherently safe to operate. As fuel temperature increases reactivity decreases. The fuel design employs one, two or more fuel configurations and is comprised of the materials listed above, nickel, aluminum, zirconium vanadium hydrogen deuterium but with varying concentrations of fissile plutonium or uranium isotopes, varying concentrations of fertile materials and varying ratios of hydrogen atoms to uranium or plutonium atoms and thorium atoms in the various metals comprising the intermetalic hydrides under the exterior barrier materials comprising the cladding such as zirconium alloy and in the varying concentrations of hydrogen in the inert metal matrix alloy containing the actinides. The concentration of hydride fuel is determined from how much softening the neutron spectrum is needed to achieve the optimal negative reactivity coefficients, breeding ratio and nuclear waste incineration rate. The negative reactivity feedback of the fuel is an essential feature to control the reactor in case of a power excursion or loss of coolant accident.

The invention also provides a fast core with a cylindrical or cubic shape and having a fast neutron spectrum or intermediate spectrum softened by hydrides and with neutron reflection/absorption from the rotating reflectors on the circumference of the core. The reflectors/absorbers for the fast spectrum are fabricated from tungsten holmium and tungsten gadolinium on one side and nickel iron (Monel) on the other. In an alternate embodiment, the core will have an epithermal neutron spectrum with similar reflection and control features. The fast spectrum allows high breeding ratio, thus maximizing the core lifetime between refueling. A slightly softened spectrum such as epithermal spectrum can enhance the Doppler broadening effects, and thus enhance the negative fuel temperature coefficient of the fuel.

The invention also provides a core cooled by numerous heat pipes and thermo siphons which transfer heat to an intermediate loop and/or a secondary power conversion system which can produce electricity with a Rankine cycle. The waste heat from the system may also be used for desalination of sea water or district heating. The coolant for the power conversion system can be water or an organic coolant. The power conversion system is separated from the reactor core and its primary passive multiple redundant heat transport system (i.e. heat pipes). Additionally the core is cooled by convecting liquid coolants: liquid metals or salts for fast spectrum applications.

The invention also provides the inert metal matrix alloys, aluminum, zirconium, vanadium and nickel or any of these two or three or four alloyed in various concentrations with the actinide-hydrides or actinide doped with hydrogen or deuterium and a selected lanthanide burnable poison. The materials provided as the inert metals include aluminum, zirconium, vanadium and nickel in various combinations. The zirconium, vanadium, and/or the nickel, when added to the aluminum along with a trace amount of boron 11, give the matrix metal higher mechanical strength and stability in high temperature environments and are ideal for structural aspects of the reactor. This high temperature strength of nickel aluminide adds to the safety of the design. Aluminum has a parasitic neutron absorption property that is expected to improve the burning of problematic minor actinides in nuclear waste. The nickel provides a trapping effect for the neutrons in the inert metal matrix, and thus minimizes the core size. The zirconium permits the formation of a stable hydride to be built into the design depending on the desired neutron spectrum. The composition of this alloy comprising the inert metal matrix for fast or epithermal applications will influence the neutron spectrum to provide softening effects in the fast spectrum embodiment and in the epithermal neutron embodiment.

The invention also provides active control achieved by the rotation of neutron reflecting and neutron absorbing drums deployed around the circumference of the core. The reflector is nickel steel Monel and the absorber is tungsten holmium or tungsten gadolinium.

The invention also provides for the use of the metal matrix material nickel aluminum in configuration so that heat pipes and fuel function integrally. Nickel aluminum has high mechanical strength and thermal conductivity so the heat pipes remove heat from the fuel efficiently and so that heat is delivered to the reservoir/boiler above the core.

The invention also provides a fusible alloy of aluminum and gallium in a membrane that blocks tungsten control rods or tungsten shot from entering the core until a temperature threshold is met at which point the membrane melts and the neutron absorbing material is released to passively scram the reactor.

The invention also provides an alloy for use in the thermal spectrum to retrofit most if not all light water reactors with a thorium containing fuel so that the operator of the reactor need not produce significant quantities of plutonium, neptunium, americium and curium. This alloy is vanadium-aluminum-zirconium. This alloy can contain dispersed ceramic particles or metallic particles of thorium and fissile uranium and can be doped with hydrogen or deuterium so that the alloy functions to moderate neutrons to thermal ranges. As a high temperature hydride, it acts as a hydrogen barrier permitting the actinides to be in close contact with the hydrogen atoms to take advantage of the temperature dependent reactivity effects.

The invention also provides thorium-based non-proliferative fuels for a power reactor comprising a granular and/or particulate ceramic fuel fabricated from an element selected from the group consisting of thorium, uranium, plutonium and minor actinides in carbide, oxide, nitride, boride and/or silicide form, either alone or in any combination thereof; a granular and/or particulate hydride actinide fuel component selected from the group consisting of thorium hydride, zirconium hydride, and uranium hydride, either alone or any combination thereof; a selected lanthanide for use as a burnable poison in contiguous locations; wherein one or more of the ceramic fuel, selected hydride, and hydride are sealed under a coating or layering selected from the group consisting of graphite, silicon carbide, zirconium carbide, and silicon, either alone or in any combinations thereof; and wherein all of the ceramic fuel particles or grains and the hydride fuel grains or particles, either alone or in any combination, are dispersed in an inert metal matrix selected from the group consisting of nickel-aluminum, zirconium-aluminum, zirconium-nickel, aluminum vanadium or nickel-zirconium-vanadium-aluminum alloy, either alone or in any combination thereof as determined by the desired operating temperature of the reactor and as determined by the volume of the reactor and the spectrum selected for the reactor. Use of uranium 232 as the denaturant to reduce risks of proliferation along with its precursor proactinium 231 as a burnable poison, each being produced in and introduced in the reactor as spectrum and reactor volume specifications warrant.

The invention also provides novel alloys for the production of medical isotopes and commercial isotopes. The alloys and target precursor materials and fissile and fertile materials are enclosed in engineered target assemblies designed to be irradiated in the thermal neutron spectrum. This target is a neutron multiplier and it irradiates the target material with a more energetic spectrum. This fast spectrum is needed to efficiently produce many desired isotopes for medical and commercial purposes.

The invention also provides novel alloys to replace heavily enriched uranium in test and experimental reactors enabling the reactors to be more non-proliferative than if powered by heavily enriched uranium by the use of uranium 232 as a denaturant for both uranium 233 produced and uranium 235 that could be present in the fuel at start up, and avoiding the use of uranium 238 in the fuel as it is one capture away from plutonium 239.

The foregoing disclosure is sufficient to enable one having skill in the art to practice the invention without undue experimentation, and provides the best mode of practicing the invention presently contemplated by the inventor. While there is provided herein a full and complete disclosure of the preferred embodiments of this invention, it is not intended to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Accordingly, the proper scope of the present invention should be determined only by the broadest interpretation of the appended claims so as to encompass all such modifications as well as all relationships equivalent to those illustrated in the drawings and described in the specification.

What is claimed as invention is:

1. A thorium-based non proliferative fuel for a power reactor, said fuel comprising:
a fertile/fissile fuel mix comprising material selected from the group consisting of oxides of thorium, fissile uranium, and oxides of fissile reactor grade plutonium;
a selected lanthanide for use as a burnable poison;
wherein said fuel mix is dispersed in an inert metal matrix selected from the group consisting of aluminum, nickel, zirconium, vanadium, nickel-aluminum-zirconium, vanadium-aluminum-zirconium, and aluminum-zirconium-vanadium.

2. The thorium-based non proliferative fuel for a power reactor of claim 1, wherein said fertile/fissile fuel mix and said selected lanthanide are coated with a material selected from the group consisting of borides, nitrides, carbides or silicides so as to create a coated fuel mix.

3. The thorium-based non proliferative fuel for a power reactor of claim 1, wherein said fertile/fissile fuel mix comprises ceramic particles.

4. The thorium-based non proliferative fuel for a power reactor of claim 1, wherein said fertile/fissile fuel mix comprises metallic particles.

5. The thorium-based non proliferative fuel for a power reactor of claim 1, wherein said fertile/fissile fuel mix further includes a hydride.

6. The thorium-based non proliferative fuel for a power reactor of claim 1, wherein said fertile/fissile fuel mix further includes deuterium.

7. The thorium-based non proliferative fuel for a power reactor of claim 1, wherein said fertile/fissile fuel further includes aluminum phosphate for xenon gas control.

8. The thorium-based non proliferative fuel for a power reactor of claim 1, wherein said fertile/fissile fuel mix further includes tritium.

9. The thorium-based non proliferative fuel for a power reactor of claim 1, wherein said inert metal matrix comprises a compound alloy selected from the group consisting of aluminum, nickel, zirconium, titanium, niobium, tantalum, hafnium, vanadium, tungsten, and molybdenum.

10. The thorium-based non proliferative fuel for a power reactor of claim 1, wherein said inert metal matrix includes a material selected from the group consisting of hydrogen, deuterium, a high temperature hydride, zirconium hydride, vanadium hydride, and erbium hydride added in the amount consistent with and tailored for the desired neutron spectrum for the particular application.

11. The thorium-based non proliferative fuel for a power reactor of claim 1, wherein said fuel mix is granular.

12. A thorium-based non-proliferative fuel for a power reactor, said fuel comprising:
a ceramic oxide fuel fabricated from an element selected from the group consisting of thorium, uranium, plutonium and minor actinides;
a hydride actinide fuel component selected from the group consisting of thorium hydride, zirconium hydride, and uranium hydride; and
a selected lanthanide for use as a burnable poison in contiguous locations; wherein all of said ceramic fuel and said hydride actinide fuel component are dispersed in an inert metal matrix selected from the group consisting of nickel-aluminum, zirconium-aluminum, zirconium-nickel, aluminum vanadium or nickel-zirconium-vanadium-aluminum alloy.

13. The thorium-based non-proliferative fuel for a power reactor of claim 12, wherein one or more of said ceramic oxide fuel, said hydride actinide fuel component, and said selected lanthanide are sealed under a coating selected from the group consisting of graphite, silicon carbide, zirconium carbide, and silicon.

14. The thorium-based non-proliferative fuel for a power reactor of claim 12, wherein said minor actinides are in a form selected from the group consisting of carbide, oxide, nitride, boride, and silicide.

15. The thorium-based non-proliferative fuel for a power reactor of claim 12, wherein said fuel is granular.

16. The thorium-based non-proliferative fuel for a power reactor of claim 12, wherein said fuel is particulate.

17. The thorium-based non-proliferative fuel for a power reactor of claim 12, further including uranium 232 as a denaturant to reduce risks of proliferation.

18. The thorium-based non-proliferative fuel for a power reactor of claim 12, further including proactinium 231 as a burnable poison.

19. A material for the production of isotopes, said material comprising:
an alloy selected from the group consisting of aluminum, nickel, zirconium, vanadium, nickel-aluminum-zirconium, vanadium-aluminum-zirconium, and aluminum-zirconium-vanadium; and
a fissile material selected from the group consisting of uranium 233, uranium 235, and plutonium 239 in a form selected from the group consisting of metallic, oxide, carbide, nitride, and boride; wherein said fissile material is used to irradiate a target with a more energetic neutron spectrum that is modified by the metallic components of said alloy to maximize the transmission of neutrons at controlled energies to maximize the transmutation of the target at the same time retaining fission products to avoid contamination of the isotopes produced.

20. The material for the production of isotopes of claim 19, wherein said alloy is used to fashion target assemblies for the production of isotopes at high energy, and has epithermal and thermal neutron spectrum shaped by the addition of a material selected from the group consisting of hydrides, nitrides and borides for managing spectrum energies to enhance neutron capture by the target material selected to produce the isotope of interest.
